(19) United States
(12) Patent Application Publication
(10) Pub. No.: US 2005/0050776 A1
(43) Pub. Date: Mar. 10, 2005

(54) Crypt memorialization system

(76) Inventor: Ted Tingesdahl, Janesville, WI (US)

Correspondence Address: REED SMITH LLP, P.O. BOX 488, PITTSBURGH, PA, 15230-0488, US

(21) Appl. No.: 10/879,693

(22) Filed: Jun. 28, 2004

Related U.S. Application Data
(60) Provisional application No. 60/494,441, filed on Aug. 11, 2003.

(51) Int. Cl. G09F 19/00; G09F 7/02

(52) U.S. Cl. 40/124.5; 40/618

(57) ABSTRACT

An identification and memorialization apparatus comprising a decorative closed frame and at least one identification element removably attached to the frame where the system is removably mounted on the facade or shutter of the mausoleum crypt, columbarium or niche.

This application claims the benefit under 35 USC 119(e) of U.S. Provisional Application Ser. No. 60/494,441 filed Aug. 11, 2003.

### FIELD OF THE INVENTION

The present invention relates in general to an identification and memorialization apparatus and more particularly to a system comprising a decorative frame and at least one identification element removably attached to the frame where the system is removably mounted on the facade or shutter of the mausoleum crypt, columbarium or niche.

### BACKGROUND OF THE INVENTION

Historically, when decedents have been entombed in a mausoleum crypt, columbarium or niche, there has been no acceptable temporary apparatus or method for identifying and memorializing the decedent which can be implemented at the entombment site prior to the memorial service. Traditionally. the granite or marble shutter would be removed and sent to a monument shop for sandblasting the decedent's name, years of birth and death, etc., on the shutter for identification and memorialization. Such process usually takes about two to four weeks and thus cannot be performed in time for the memorial service. Likewise, other prior apparatus and methods for identification and memorialization also are not conducive to short turn around times. A bronze plaque or scroll normally requires four to eight weeks lead time and the practice of gluing or otherwise affixing loose bronze letters to the shutter or facade also cannot normally be performed prior to the memorial service or funeral.

As a result, Matthews International Corporation (the assignee of the present invention”) developed an identification and memorialization apparatus and method (“Matthews prior arrangement”) that could be implemented in time for the memorial or funeral service and which provided the appearance and decorum of the traditional identification and memorialization devices.

As shown in FIGS. 1-6, the apparatus 100 of the Matthews prior arrangement comprised an open frame 120 and at least one bar 140 having at least one slot or channel 160. The open frame comprised four sides forming a rectangle with an open central rectangular area. The channels 160 (FIGS. 3-4) received the feet 180 of alphanumeric characters 200 used for identification and memorialization of the decedent. Means for attaching the bar 140 to the frame 120 included tabs 220 having a hole 240 drilled and/or tapped therein for the purpose of receiving a screw 250 or other fastening device (FIGS. 5-6.) Holes 260 in the bar 140 were provided for purposes of fastening the bar 140 to the frame 120. As shown in FIG. 1, the bar 140 carrying the alphanumeric characters 200 could be mounted in a frame 120 in which a permanent plaque 400 has been previously mounted to identify and memorialize a prior decedent entombed in the crypt. Alternatively, in another Matthews prior arrangement shown in FIG. 7, the bar 140 could be mounted on a temporary plaque 420 before mounting on the open frame 120.

Of late, however, some disadvantages have been noted in connection with Matthews prior arrangement. The open frame is difficult to cast and it is difficult to achieve a uniform product having squared corners due to uneven shrinkage during the manufacturing process. Also, it is difficult to attach the bars to the tabs due to casting tolerances and drilling issues.

### SUMMARY OF THE INVENTION

In accordance with one embodiment of the present invention, the apparatus of the present invention comprises a closed frame and at least one temporary plate attached to the front face of the frame. The closed frame comprises a rectangular shape having solid front and rear faces. Each temporary plate has at least one bar mounted across the front face of the frame having means for mounting alphanumeric characters used for identification and memorialization of the decedent.

The closed frame of the present invention is easier to cast than the open frame of the prior arrangement. When pouring liquid metal into the mold for the open frame of the prior arrangement, it was difficult to produce a uniform product. Those difficulties are overcome with a closed frame mold. The present invention may be produced using a standard foundry line with reduced tooling time. The castings stay true to pattern with no warpage or adverse shrinkage. The closed frame of the present invention has improved durability due to increased metal percentages. The manufacturing process of the present invention results in reduced scrap castings and missed pours. The resulting product has increased aesthetics due to squared castings. Furthermore, there are no insert issues or gaps between scrolls and the vertical alignment of scrolls is improved.

### BRIEF DESCRIPTION OF THE DRAWINGS

The present invention and its presently preferred embodiments will be better understood by way of reference to the detailed disclosure herebelow and to the accompanying drawings, wherein:

FIG. 1 is a front view of the prior art arrangement;

FIG. 2 is a front view of a bar of the prior art;

FIG. 3 is a cross-sectional view of the bar of FIG. 2;

FIG. 4 is a partial rear view of the bar of FIG. 2 and an alphanumeric character;

FIG. 5 is a front view of a prior art open frame;

FIG. 6 is a partial view showing the attaching means of the prior art;

FIG. 7 is front view of an alternative prior art arrangement;

FIG. 8 is a front view of the closed frame of the present invention;

FIG. 9 is a front view of the crypt memorial of the present invention;

FIG. 10 is a rear view of the closed frame of the present invention;

FIG. 11 is a front view of a permanent plate of the present invention;

FIG. 12 is a side cross-sectional view of the temporary plate of the present invention;

FIG. 13 is a front view of the temporary plate of the present invention; and

FIG. 14 a front view of the bar of the present invention.

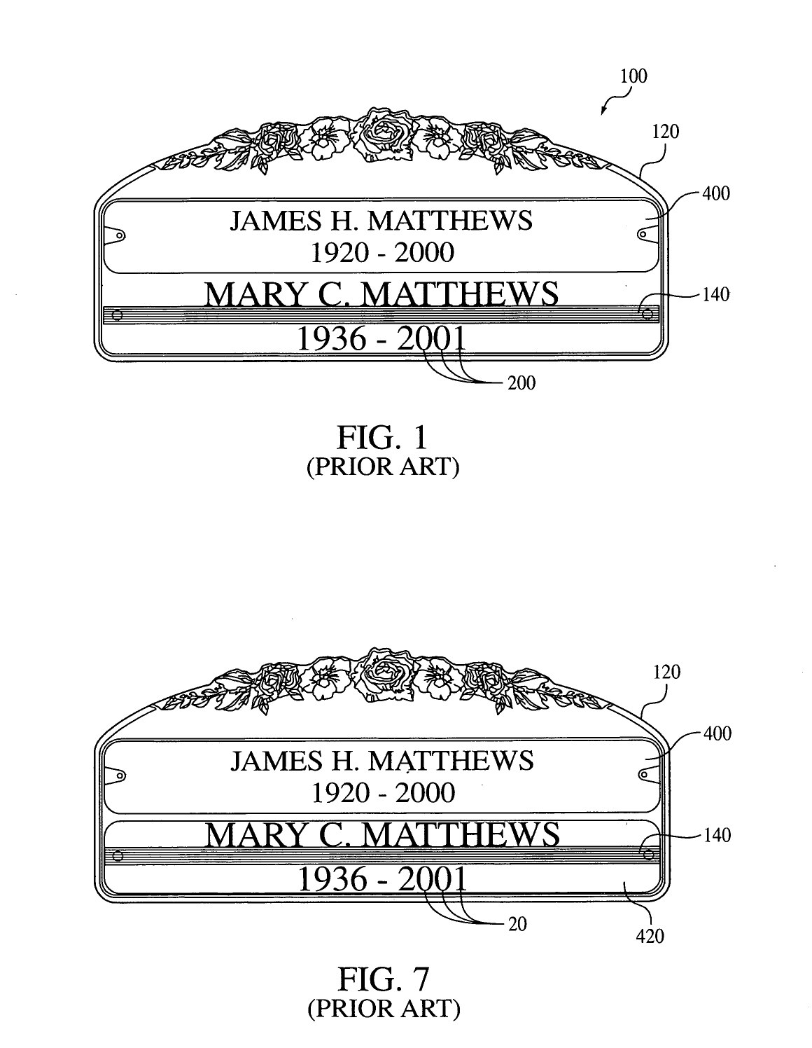

### DETAILED DESCRIPTION OF THE PREFERRED EMBODIMENTS

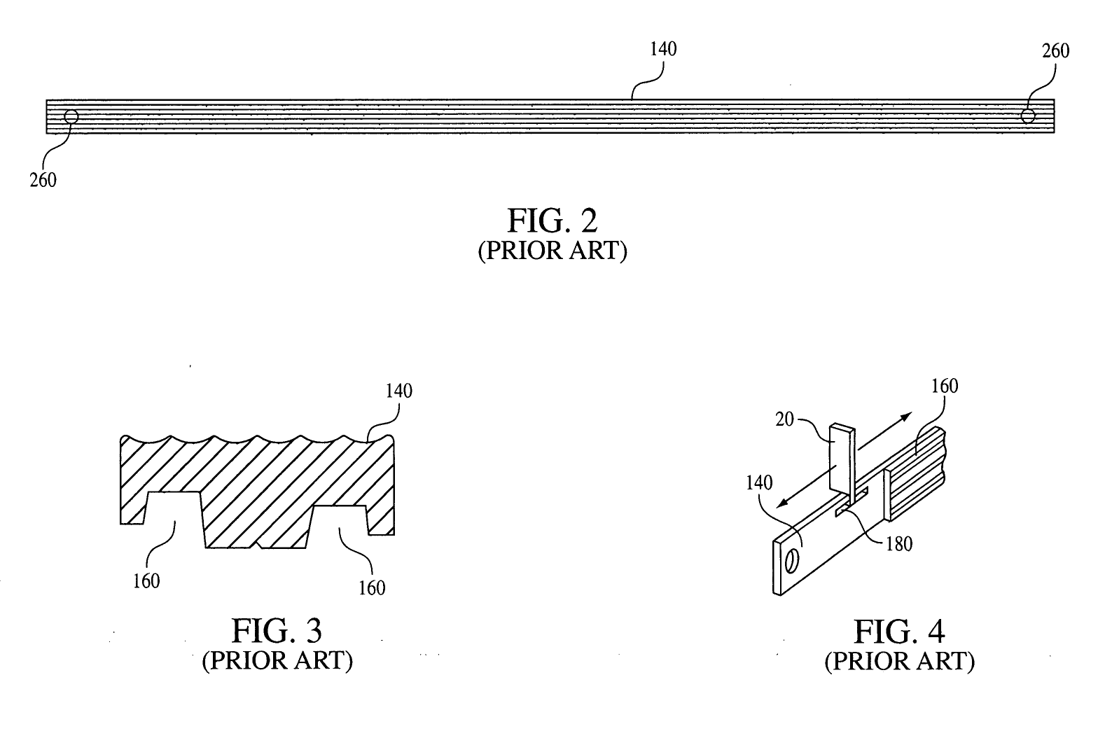

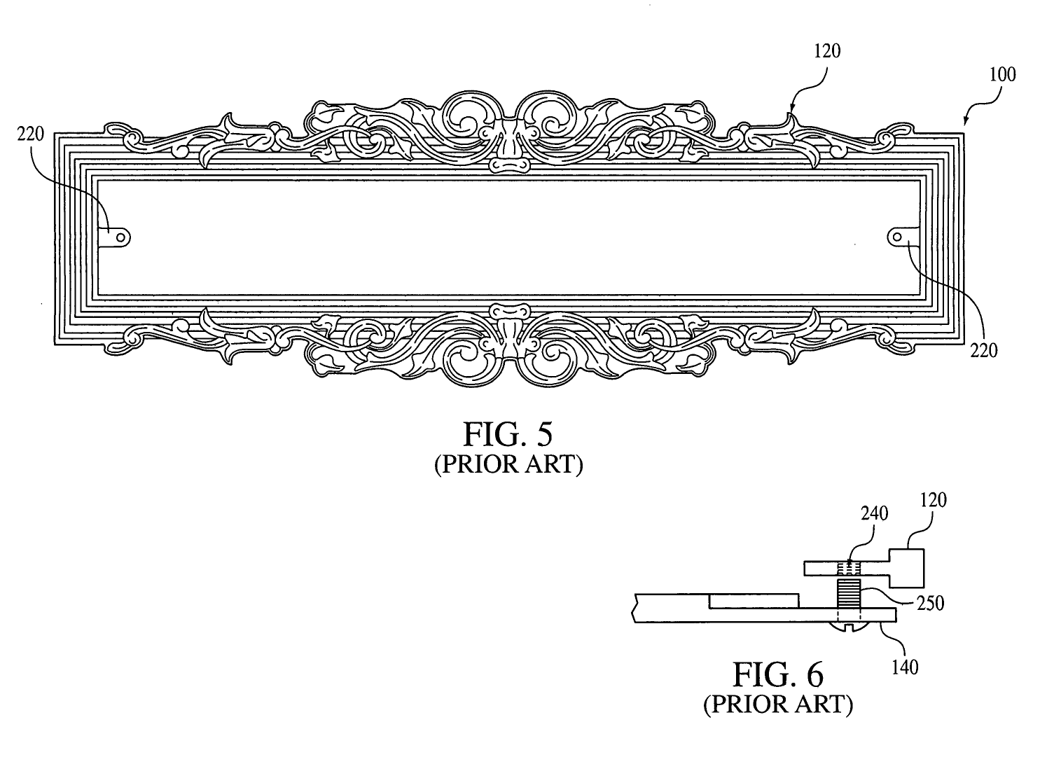

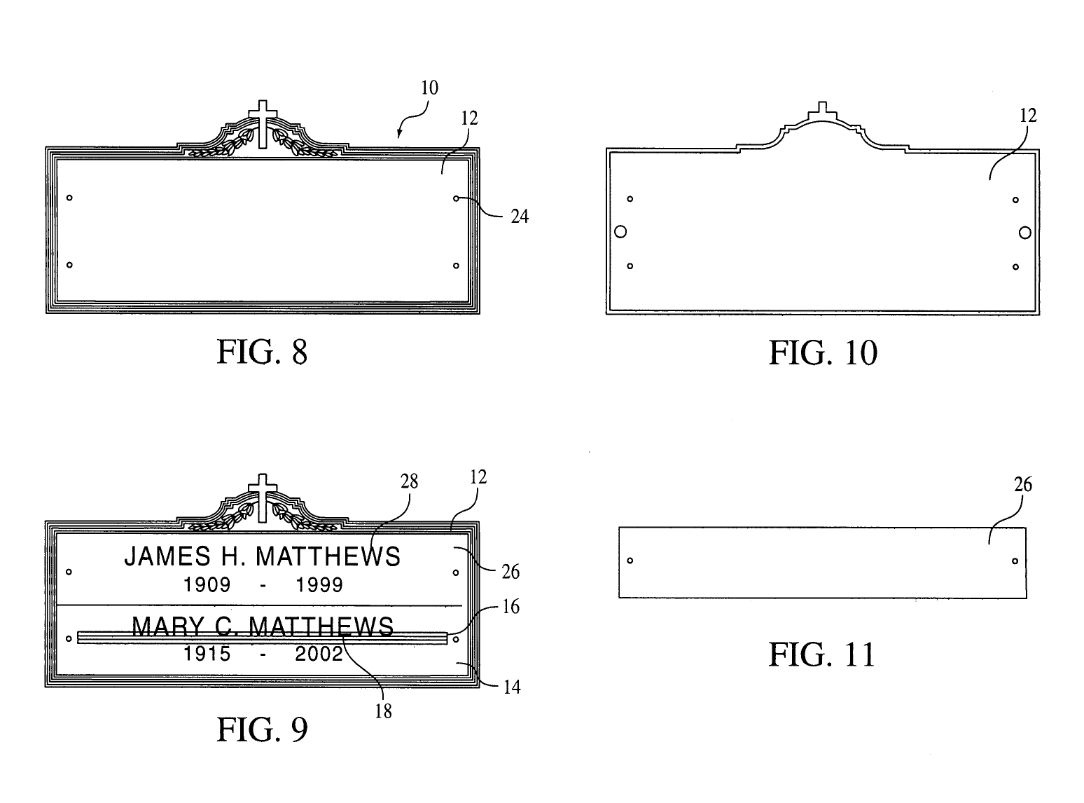

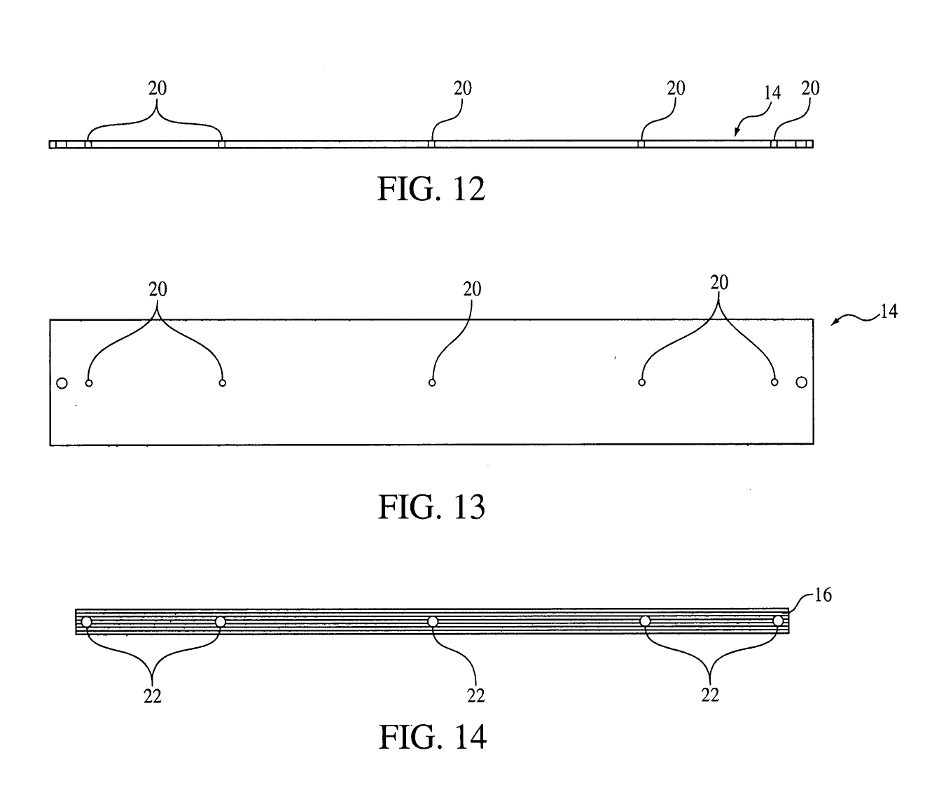

The present invention is an identification and memorialization apparatus comprising a decorative frame removably mountable on the facade or shutter of the mausoleum crypt, columbarium or niche. As shown in FIGS. 8-14, the apparatus 10 of the present invention comprises a closed frame 12 and at least one temporary plate 14 attached to the front face of the frame 12. The closed frame comprises a rectangular shape having solid front and rear faces. The closed frame preferably has ornamentation across the four side edges of the front face. Each temporary plate has at least one bar mounted across the front face of the plate 14 at about the vertical midpoint of the plate 14. As in the prior art arrangement of FIGS. 3-4, each bar has at least one horizontal slot or channel on the rear face thereof. The bar preferably includes two channels receiving the feet of alphanumeric characters 18 used for identification and memorialization of the decedent. The bar 16 is preferably attached to the plate by means of holes 20 (in the illustrated embodiment five holes are used) drilled and/or tapped in the plate 14 and holes 22 drilled and/or tapped in the bar 16 for the purpose of receiving a screw or other fastening device. Holes 22 are also drilled and/or tapped in the bar 16 for the purpose of fastening the bar 16 to corresponding holes 24 (in this illustrated embodiment two holes are used) in the frame 12.

As shown in FIG. 9, a temporary plate 14 carrying the alphanumeric characters 18 may be mounted to a frame 12 in which a permanent plate 26 has been previously mounted to identify and memorialize a prior decedent entombed in the crypt. The permanent plate 26 and the alphanumeric characters 28 integral therewith are formed by way of a casting process so that the permanent plate and the alphanumeric characters form a gaplessly continues piece.

Although the present invention has been described in detail for the purpose of illustration, it is to be understood that such detail is solely for that purpose and that variations can be made therein by those in the art without departing form the spirit and scope of the invention.

1. A memorialization apparatus comprising:
a closed frame having solid front and rear faces;
at least one temporary plate removeably mounted to the front face of the closed frame, the plate having front and rear faces;
a bar mounted on the front face of the at least one temporary plate, said bar adapted for removeably receiving alphanumeric characters.

2. The apparatus of claim 1, wherein the at least one plate includes at least one hole and said closed frame includes at least one hole for receiving a fastener for mounting the at least one temporary plate to the closed frame.

3. The apparatus of claim 1, wherein the bar includes at least one channel for receiving feet of the alphanumeric characters.

4. The apparatus of claim 1, further including at least one permanent plate having integral alphanumeric characters together with the at least one permanent plate forming a continues gapless piece, the at least one permanent plate mountable to the front face of the closed frame after the at least one temporary plate is removed.
